(19) United States
(12) Patent Application Publication
(10) Pub. No.: US 2011/0320134 A1
(43) Pub. Date: Dec. 29, 2011

(54) Smart Faucet and Water Filtration System and Method

(76) Inventors: Andy Butler, Palo Alto, CA (US); F. Iannce, Sunnyvale, CA (US); Todd Pope, Napa, CA (US); Jackie Lai, Sunnyvale, CA (US); Lesley Silverthorn, Redwood City, CA (US); Jeffrey Godfrey, Fairfield, CA (US); Ray Brown, Barrington Hills, IL (US)

(21) Appl. No.: 13/098,175

(22) Filed: Apr. 29, 2011

Related U.S. Application Data
(60) Provisional application No. 61/329,430, filed on Apr. 29, 2010.
(60) Provisional application No. 61/371,601, filed on Aug. 6, 2010.

(51) Int. Cl. G06F 19/00

(52) U.S. Cl. 702/25

(57) ABSTRACT

A system and method for automatically monitoring water quality information directly by using sensors to test water in a plumbing system or indirectly by monitoring government or other warnings that can be received wireless or over wireline. In response the system and method identify a water treatment/enhancement protocol and perform this protocol on the water supply in the house/building.

### RELATED APPLICATIONS

This application is related to and claims priority from U.S. Provisional application 61/329,430 filed on Apr. 29, 2010 and U.S. Provisional application No. 61/371,601 filed on Aug. 6, 2010 which are incorporated by reference herein in their entirety.

### FIELD OF THE INVENTION

The invention relates to the field of water filters and more particularly to smart faucets and water filtration systems.

### BACKGROUND

A common public health safety provision in the supply of municipal drinking water is an agency initiated “boil-water” advisory, which public water suppliers and municipal water suppliers issue in response to “shocks” to the treatment or transmission of public drinking water. Such shocks are usually temporary, but result in the agency not being able to ensure that the microbiological quality of the supplied water meets federal standards of safety. These advisories typically occur after severe storms, power outages, flooding and other natural and man-made disasters. Advisories are then picked up by local media outlets (television, radio, print) and broadcast to the populations in an affected area. However, there is currently no mechanism for ensuring that these boil water advisories are received at the household or individual business level at the time of need.

Another common problem is ensuring proper hand sanitation, for example after the preparation of food such as after handling red meat, after restroom use,

### SUMMARY

A system and method for determining sanitation protocols for a liquid dispensing device comprising the steps of: automatically identifying a first user located in proximity of the liquid dispensing device; automatically determining whether a first liquid treatment/enhancement protocol is associated with said first user; and implementing said first liquid treatment/enhancement protocol when said first user utilizes the liquid dispensing device. In an embodiment said step of implementing said first liquid treatment protocol comprises: performing a liquid treatment operation on liquid before said liquid is dispensed by the liquid dispensing device, wherein said liquid treatment operation comprises: performing a cleansing operation on the liquid including at least one of exposing the liquid to ultra-violet radiation, filtering the liquid, distilling the liquid, applying disinfecting chemicals to the liquid and/or passing the liquid through an absorption media. In an embodiment wherein said step of implementing said first liquid treatment protocol comprises: performing a mixing operation on liquid before said liquid is dispensed by the liquid dispensing device and wherein said mixing operation includes mixing one of a cleansing agent and/or an enhancement agent with said liquid.

In an embodiment said step of implementing said first liquid treatment protocol comprises: performing a mixing operation on liquid before said liquid is dispensed by the liquid dispensing device, wherein said mixing operation includes mixing one of a cleansing agent and/or an enhancement agent with said liquid.

Another embodiment is a computer based method for determining sanitation protocols for a liquid dispensing device in a plumbing system comprising the steps of: identifying a safety status of the liquid; automatically determining whether a first liquid treatment protocol is necessary based on said safety status; and implementing said first liquid treatment protocol when said first liquid treatment protocol is necessary based upon said safety status, wherein said step of identifying said safety status comprises monitoring a liquid in the plumbing system and wherein said monitoring step includes: performing an analysis of the liquid including at least one of a chemical analysis, optical analysis, pressure analysis, and/or contaminant analysis. In an embodiment said step of implementing said first liquid treatment protocol comprises: performing a liquid treatment operation on liquid before said liquid is dispensed by the liquid dispensing device, wherein said liquid treatment operation comprises: performing a cleansing operation on the liquid including at least one of exposing the liquid to ultra-violet radiation, filtering the liquid, distilling the liquid, applying disinfecting chemicals to the liquid and/or passing the liquid through an absorption media.

In an embodiment said step of identifying said safety status comprises monitoring a third party communication related to said safety status of said liquid and wherein said step of implementing said first liquid treatment protocol comprises: performing a liquid treatment operation on liquid before said liquid is dispensed by the liquid dispensing device. In an embodiment the liquid treatment operation comprises: performing a cleansing operation on the liquid including at least one of exposing the liquid to ultra-violet radiation, filtering the liquid, distilling the liquid, applying disinfecting chemicals to the liquid and/or passing the liquid through an absorption media.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is an illustration of an environment in which one embodiment may operate.

FIG. 2 is a more detailed illustration of a monitor in accordance with an embodiment.

FIG. 3 is a more detailed illustration of a remote server in accordance with an embodiment.

FIG. 4 is an illustration of an environment having a combination of a water treatment system and a water dispensing system in which one embodiment may operate.

FIG. 5 is a flowchart of the operation of a user recognition and washing protocol in accordance with an embodiment.

FIG. 6 is a flowchart of the operation of a water monitoring and water treatment protocol in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A preferred embodiment of the present invention is now described. Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

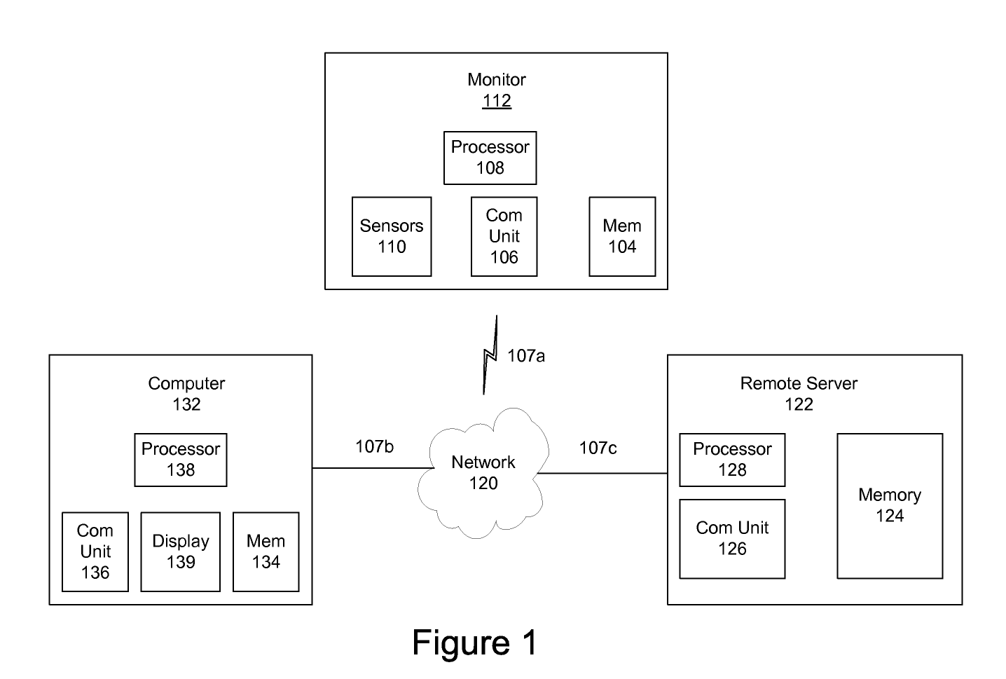

FIG. 1 is an illustration of an environment in which one embodiment may operate. The operating environment may include a monitor 112 which can include a processor 108, a memory device 104, a communications unit 106 and sensors 110. A communication link 107a provides for communications between the monitor 112 and a network 120. The communication links 107 described herein can directly or indirectly connect these devices as well as computer 132 and remote server 122. The network 120 can be, for example, a wireline or wireless communication network such as a WiFi, other wireless local area network (WLAN), a cellular network comprised of multiple base stations, controllers, and a core network that typically includes multiple switching entities and gateways. Other examples of the network 120 include the Internet, a public-switched telephone network (PSTN), a packet-switching network, a frame-relay network, a fiber-optic network, combinations thereof, and/or other types/combinations of networks.

Processors 108, 128 and/or 138 process data signals and may comprise various computing architectures including a complex instruction set computer (CISC) architecture, a reduced instruction set computer (RISC) architecture, or an architecture implementing a combination of instruction sets. Although only a single processor is shown in FIG. 1 in each device, multiple processors may be included. The processors can comprise an arithmetic logic unit, a microprocessor, a microcontroller, a general purpose computer, or some other information appliance equipped to transmit, receive and process electronic data signals from the memory 104, 124, 134 and other devices both shown and not shown in the figures.

The remote server 122 includes a processor 128, examples of which are described above, and a communication unit 126 for communicating with the network 120, for example. The remote server 122 also includes a memory module 124 that in embodiments can be volatile and/or non-volatile memory, e.g., the memory 124 may be a storage device such as a non-transitory computer-readable storage medium such as a hard drive, compact disk read-only memory (CD-ROM), DVD, or a solid-state memory device. The memory 124 can be physically part of the remote server 122 or can be remote from the remote server 122, e.g., communicatively coupled to the remote server 122 via a wired/wireless connection, via a local area network (LAN), via a wide area network (WAN), via the Network 120, etc. For ease of discussion the memory 124 is described herein as being part of the remote server 122. Additional details regarding the operation of the remote server are set forth herein.

The computer 132 can be any computing device capable of executing computer modules/code for the functions described herein. For example, the computer can be a personal computer (PC) running on a Windows operating system that is commercially available from Microsoft Corp, Redmond, Wash., a computer running the Mac OS (and variations of) that is commercially available from Apple Computer, Inc., Cupertino, Calif., or other operating systems, a personal device assistant (PDA), a smart phone, e.g., an iPhone, commercially available from Apple Computer Inc. or a phone running the Android operating system, commercially available from Google, Inc, Mountain View, Calif. Other examples include a smart-watch, at tablet computer, e.g., the iPad (commercially available from Apple Computer, Inc) or any other device that can communicate with a network. For ease of discussion, the computer 132 will be described as a personal computer. The computer 132 includes a processor 138, as described above, a communication unit 136 for communicating with the network, a memory module 134, such as the memory modules described herein and an input/output unit 139 that can include input devices, e.g., keyboard, touch screen, mouse and output devices, e.g., a display. The computer 132 and the remote server 122 can be the same device in some embodiments.

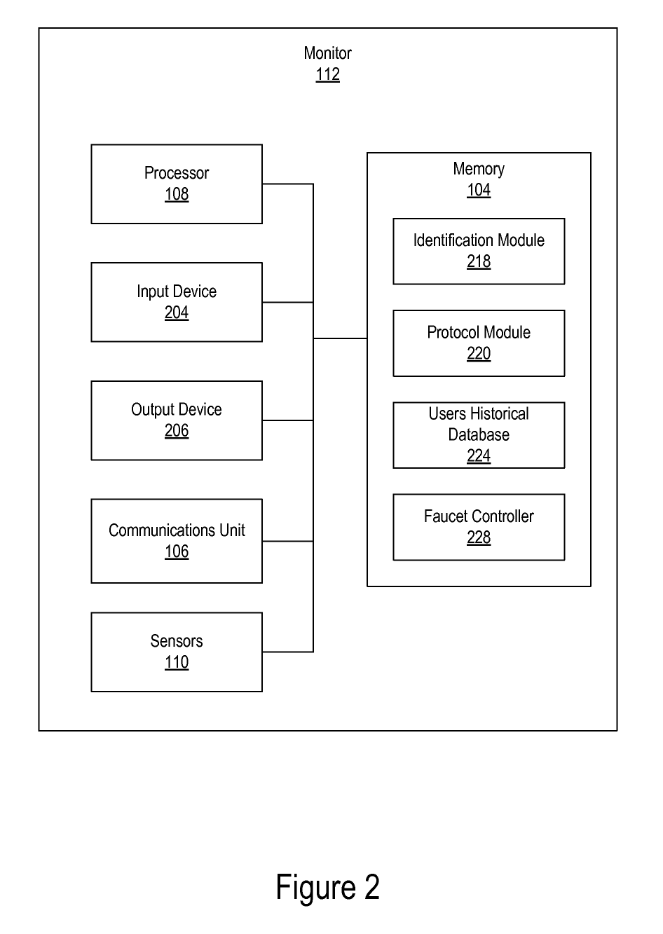

FIG. 2 is a more detailed illustration of a monitor 112 in accordance with an embodiment. The monitor includes a processor 108, an input device 204, an output device 206, a communications unit 106 (transceiver device), sensors 110 and memory 104.

As described above, the processor 108 processes data signals and may comprise various computing architectures including a complex instruction set computer (CISC) architecture, a reduced instruction set computer (RISC) architecture, or an architecture implementing a combination of instruction sets. The processor 108 can be an arithmetic logic unit, a microprocessor, a microcontroller, a general purpose computer, or some other information appliance equipped to transmit, receive and process electronic data signals from the memory 104, the input device 204, the output device 206, the communications unit 106, and/or the sensors 110.

The input device 204 is optional and includes any device configured to provide direct or indirect user input to the monitor 112 such as, a cursor controller or a keyboard. In one embodiment, the input device 204 can include an alphanumeric input device, such as a QWERTY keyboard, a key pad or representations of such created on a touch screen, adapted to communicate information and/or command selections to processor 108 or memory 104. In another embodiment, the input device 204 is a user input device equipped to communicate positional data as well as command selections to processor 108 such as a joystick, a mouse, a trackball, a stylus, a pen, a touch screen, cursor direction keys or other mechanisms to cause movement adjustment of an image.

The output device 206 is also optional in some embodiments (as are many of the modules depending upon the embodiment) and represents any device equipped to display electronic images and data as described herein. Output device 206 may be, for example, an organic light emitting diode display (OLED), liquid crystal display (LCD), cathode ray tube (CRT) display, or any other similarly equipped display device, screen or monitor. In one embodiment, output device 206 is equipped with a touch screen in which a touch-sensitive, transparent panel covers the screen of output device 206. In one embodiment, the output device 206 is equipped with a speaker that outputs audio.

The communication unit 106 represents a device that allows the monitor 112 to communicate with entities via the network 120 and to components in the system, e.g., faucet controller 228 and sensors 110.

Sensors 110 can include a biometric sensor for identification purposes. Examples include the use of voice recognition, face recognition, fingerprint recognition, feature recognition, retina recognition etc., for user identification. Sensors 110 can also include a flow sensor, temperature sensor (of water and/or air), pressure sensor, optical sensor, turbidity sensor, water impurities/components/particulates sensor, e.g., to measure lead, chlorine, etc, strain gauges, and/or other sensors to monitor levels or one or more components/impurities/particulates/chemicals in the water (e.g., salt in a system that has the function to soften water). Examples of a water flow sensor include a propeller/turbine meter, differential pressure meter, vortex meter, ultrasonic meter, rotameter, or any other flow meter type. The system may also have sensors that monitor the condition of system elements such as a sacrificial zinc electrode.

The memory 104 stores instructions and/or data that may be executed by processor 108. The instructions and/or data may comprise code for performing any and/or all of the techniques described herein. As described above, memory 104 may be a dynamic random access memory (DRAM) device, a static random access memory (SRAM) device, Flash RAM (non-volatile storage), combinations of the above, or some other memory device known in the art. The memory 104 includes a plurality of modules adapted to communicate with the processor 108, the input device 204, the output device 206, the communications unit 106, and/or the sensors 110. The memory module 104 include an identification module 218 for identifying the user of a faucet or system, a protocol module 220 for identifying the washing protocol associated with the identified user and/or the protocol to be used to filter/sanitize/treat the water or other liquid in a plumbing system, a users historical database 224 that stores information about the users and can be accessed at a later time and or transmitted to remote server 122, and the faucet controller 228 for controlling the operation of the faucet, sanitizing device (e.g., soap dispenser) and a hand dryer. Additional details regarding the operation of the monitor 112 are set forth below.

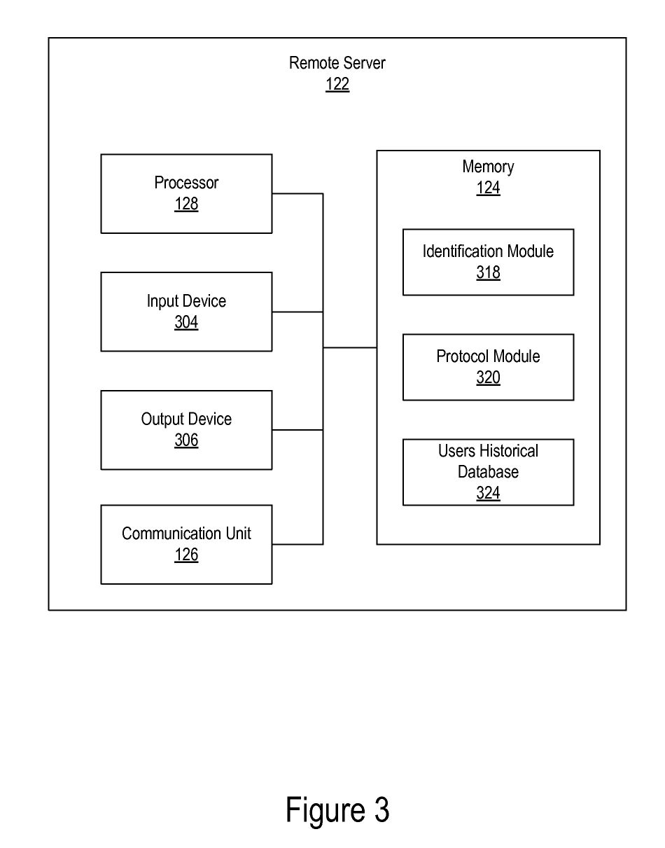

FIG. 3 is a more detailed illustration of a remote server in accordance with an embodiment. The remote server includes a processor 128 that processes data signals and may comprise various computing architectures as described above. The processor 128 can be equipped to transmit, receive and process electronic data signals from the memory 124, the input device 304, the output device 306, and the communications unit 126, for example.

The input device 304 is any device configured to provide direct user input to the remote server 122 such as, a cursor controller or a keyboard. In one embodiment, the input device 204 can include an alphanumeric input device, such as a QWERTY keyboard, a key pad or representations of such created on a touch screen, adapted to communicate information and/or command selections to processor 128 or memory 124. In another embodiment, the input device 304 is a user input device equipped to communicate positional data as well as command selections to processor 108 such as a joystick, a mouse, a trackball, a stylus, a pen, a touch screen, cursor direction keys or other mechanisms to cause movement adjustment of an image.

The output device 306 represents any device equipped to display electronic images and data as described herein. Output device 306 may be, for example, an organic light emitting diode display (OLED), liquid crystal display (LCD), cathode ray tube (CRT) display, or any other similarly equipped display device, screen or monitor. In one embodiment, output device 306 is equipped with a touch screen in which a touch-sensitive, transparent panel covers the screen of output device 306. In one embodiment, the output device 306 is equipped with a speaker that outputs audio as described herein.

The communication unit 126 represents a device that allows the remote server 122 to communicate with entities via the network 120. The memory 124 stores instructions and/or data that may be executed by processor 128. The instructions and/or data may comprise code for performing any and/or all of the techniques described herein. Memory 124 may be a dynamic random access memory (DRAM) device, a static random access memory (SRAM) device, Flash RAM (non-volatile storage), combinations of the above, or some other memory device known in the art. The memory 124 includes a plurality of modules adapted to communicate with the processor 128, the input device 304, the output device 306, and/or the communications unit 126.

The memory 124 includes an identification module 318 to assist in identifying the user, a protocol monitor to identify the protocol to be used by the identified user and a users historical database to store information about the users protocol procedures. In an embodiment the monitor 112 can identify the user, identify the protocol and maintain a users database, in other embodiments the remote server 122 can perform these function entirely or with assistance from the monitor 112.

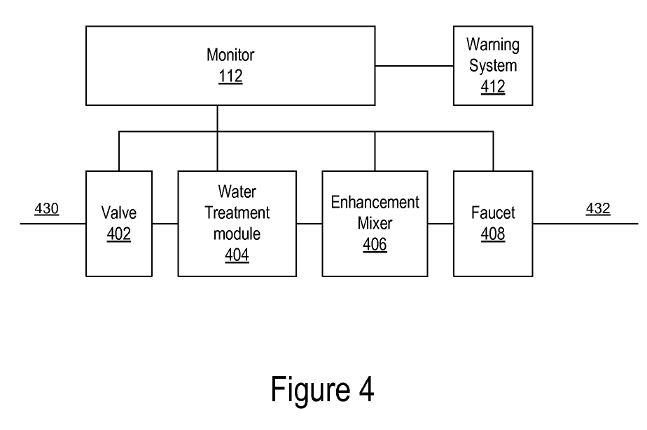

FIG. 4 is an illustration of an environment having a combination of a water treatment system and a water dispensing system in which one embodiment may operate.

The water dispensing system may be a faucet wherein artificial intelligence, fuzzy logic and/or algorithms are incorporated into the room monitor 112 such that the system can (1) recognize a type of user and determine a use protocol, and (2) dispense a metered amount of treated water and/or treated water that is mixed with an enhancing agent according to a pre-determined water treatment/enhancement protocol; and/or (3) respond to alerts internally or externally generated by altering the water treatment/process (e.g., the substance delivered) or turning off the system.

The system can include the room monitor 112, a valve 402, a water treatment module 404, an enhanced mixer 406 a faucet 408 and a warning system 412. In FIG. 4, the system includes an input 430 and an output 432. These can be part of the mainline of the plumbing system, can be a branch that has multiple devices serially located thereon, be a branch that ends at a faucet, etc. In the figures, in addition to the output at the faucet, e.g., 408, there is another output 432 that can lead to other portions of the plumbing system.

An inflow of water 430 enters the water treatment module 404 wherein it is filtered, purified or otherwise treated to remove waterborne contaminants. A plurality of treatment methods can be employed by the water treatment device, including but not limited to ultra-violet (UV) light, ozonation, distillation, absorption media, ion-exchange media, membrane separation, chemical disinfection, and the like.

Attached either directly or indirectly to the water treatment module 404, by means of typical plumbing elements for example, is a dispensing apparatus for the treated and/or treated and enhanced water. A variety of dispensing apparatus can be employed, including but not limited to faucets, taps, hoses, etc. For ease of discussion the dispensing apparatus is a faucet 408.

Further, any number of enhancing agents and/or processes can be deployed by the enhancement mixer 406 to or into the treated water, including but not limited to ozone, ultraviolet exposure, distillation, reverse osmosis, soaps, cleaning agents, degreasers, disinfecting chemicals for sanitation purposes or ingestible enhancement agents such as flavorings, carbonation, mineral supplements and the like, for consumption purposes.

The method and apparatus for altering the water processing may be incorporated into the dispensing apparatus 408 itself, into the water treatment device 404 or may be an entirely separate element within the system as a whole.

An element of the system is the monitor 112 that comprises a module (monitor 112) for defining, storing and controlling a variety of treatment/enhancement protocols. These protocols can be pre-determined /pre-programmed into the system and stored in the protocol module 220 and/or protocol module 320, depending upon whether the system uses a remote server 122, or the protocols can be user defined and self-specified. Each protocol can include the elements of water treatment (decontamination) that are applied for any given use and for determining and controlling the enhancement elements for treated water for that use. For example, a protocol may include of UV treatment and ozonation/oxygenation and carbon filtration of the influent water 430, then the addition of a metered dose of hand soap to the flow of treated water by the enhancement mixer 406, then the dispensing of that mixture from the faucet 408 for a set period of time or volume of flow (wash cycle), followed by a similar rinse cycle (without addition of soap) for a set period of time or volume of flow.

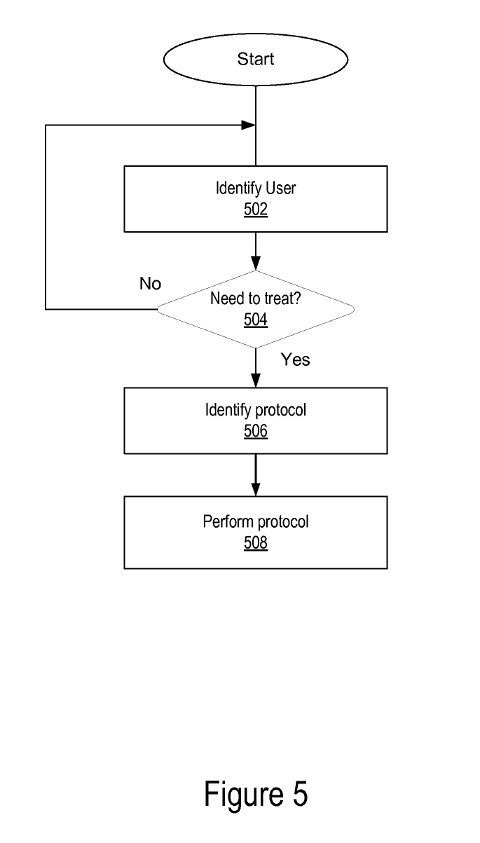

FIG. 5 is a flowchart of the operation of a user recognition and washing protocol in accordance with an embodiment. In an embodiment an aspect of this control mechanism is user recognition. In one embodiment the user recognition feature is touchless feedback system, wherein a communication link exists between a sensor (of sensors 110) that identify the user, and the dispensing apparatus 408, the water treatment module 404, and/or the enhancement mixer 406 such that when the user is recognized 502 by the identification module 218 or otherwise engages the system, it commences a water treatment and enhancement dispensing protocol associated with a profile for that type of user. The identification module determines 504 whether the identified user has a particular water treatment and enhancement dispensing protocol associated with him/her. If the monitor 112 determines 504 that water for the user need not be treated then no protocol is run, or a standard water treatment and enhancement dispensing protocol is run. If the monitor 112 determines 504 that water for the user should be treated by a protocol (either a protocol specific to the user/class/group of the user or a standard/general protocol) then the identification module 218 identifies 506 the water treatment and enhancement dispensing protocol for the user, e.g., that is stored in the protocol module 220/320 and performs/runs 508 the protocol by sending control signals to valve 402, water treatment module 404, enhancement mixer 406 and/or faucet 408.

In an embodiment the dispensing apparatus 408 then detects the presence of the user's hands or other vessel, without requiring the user to touch the dispensing apparatus, and the room monitor 112 automatically initiates and completes the pre-determined protocol. This process automatically starts and stops the protocol, which can include of a plurality of combinations and permutations of parameters such as water treatment, water temperature, flow rate, flow characteristic (e.g., steady, pulsed, etc.), duration of flow, concentration of enhancement agent, number of discrete treatment/enhancement cycles and the like. In another embodiment, the dispensing apparatus senses the presence of a drinking glass and the system automatically initiates and completes the appropriate protocol.

One embodiment of this touchless user recognition system and method uses a Radio Frequency Identification (RFID) tag that a user wears. There are a plurality of ways the user can wear an RFID tag, including but not limited to a wrist band, headwear, etc. A sensor 110 receives the information from the tag and the identification module 218 and or 318 (218/318) identifies the user, a group the user belongs to, etc.

Another embodiment includes a manual override user interface, whereby a user can self-select a protocol or combination of protocols, for dispensing user-specified enhanced water. For example, this functionality can be achieved through a waterproof membrane keypad located on or about the dispensing apparatus 408, e.g., in computer 132. The membrane or other input device 304 can be located near the dispensing apparatus 408 and/or the user can enter the identification information remotely, e.g., before engaging the dispensing apparatus.

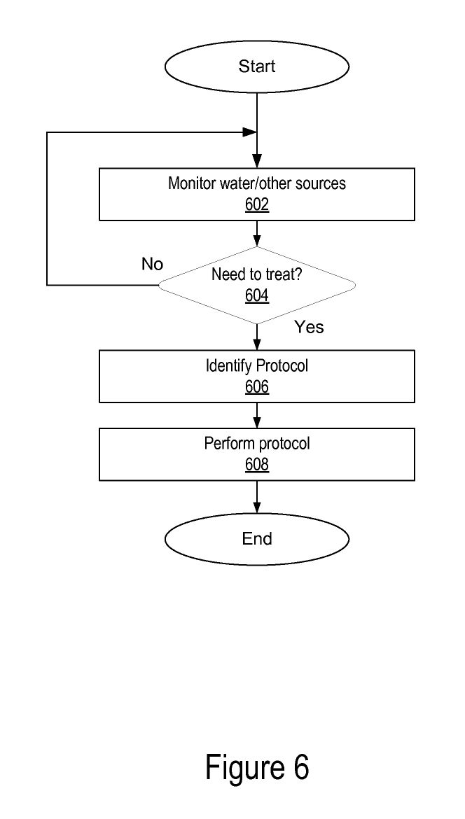

FIG. 6 is a flowchart of the operation of a water monitoring and water treatment protocol in accordance with an embodiment. Another embodiment of the intelligence system is an alert-driven communication and control system. A ubiquitous public health safety provision in the supply of municipal drinking water is an agency initiated “boil-water” advisory, which public water suppliers and municipal water supply/treatment agencies issue in response to “shocks” to the treatment or transmission of public drinking water. Such shocks are usually temporary, but result in the agency not being able to ensure that the microbiological quality of the supplied water meets federal standards of safety. These advisories typically occur after severe storms, power outages, flooding and other natural and man-made disasters. Advisories are then picked up by local media outlets (television, radio, print) and broadcast to the populations in an affected area. However, there is currently no mechanism for ensuring that these boil water advisories are received at the household or individual business level at the time of need.

A feature of an embodiment of the present invention is a point of use (POU) or point of entry (POE) water treatment and dispensing system and method that receives a wireless or wired alert/notification or some other common electromagnetic signal transmission that the incoming water supply has been compromised and has dropped below an acceptable threshold for safety. For example the communication s unit 106 can generate an alert signal and transmit to a user with an indicator, such as a sound or visual cue, and if a user is present the user could press a button (or other selector device, e.g., a soft key), give a verbal response, make a motion that could be sensed by a proximity sensor, or other method to confirm their intention to continue to have the water flow, and/or to confirm the physical presence of the user at the faucet or fixture. As described below, alternatively, the monitor 112 can send a signal (email, text, instant message, post to a social network site, e.g., Facebook, twitter, etc.) to a user who is remote, e.g., to computer 132 which can be user's phone or other computer, and the user can elect to authorize a manual override or select a protocol to use.

With reference to FIG. 6, sensor 110 monitor 602 the water and/or other sources. For example, the sensor can monitor the water for a high level of one or more contaminants and/or the communications unit can monitor and/or receive a communication from an external source, e.g., a municipal water supplier, with a warning. Based on the received input the monitor 112 determines 604 whether the water needs to be treated. The monitor 112 can monitor third party communication (including alerts to the public, postings on a website or the like) to determine the safety status of the water or other liquid.

If the water does not need to be treated the process can continue monitoring 602. If it is determined 604 that the water does need to be treated then the identification module identifies 606 the appropriate protocol based upon the input from step 602, for example, and performs 608 the protocol. For example, if after a storm a government agency issues a “boil water” advisory, the communication unit 106/126 can receive a signal with this information and the identification module 218/318 can select a water treatment protocol from the protocol module 220/320 and the monitor 112 can implement the protocol by, for example, sending control signals to the valve 402, water treatment module 404, enhancement mixer 406 and faucet 408.

In an embodiment, the system includes a fail-safe mechanism, for example, in the faucet or in the treatment system that alerts the user to the presence of unsafe water and/or alters the water processing steps it applies to the incoming water. One embodiment of this fail-safe mechanism is a valve 402 that can close and prevent water flow in the event that a warning signal is received by the system and the system does not have the capability to overcome the problem.

Another embodiment of the fail-safe system and method is the triggering of an automated disinfection or an enhanced water purification protocol cycle that can self-initiate when a warning signal is received and can restore the safety of the supplied water before it can be dispensed from the faucet.

In addition, a warning system 412 can be employed using any of a variety of alarms or indicators to signal the user that the water is unsafe and/or is being sanitized by the system in real-time. These alarms include, but are not limited to, visual indicators such as light emitting diodes (LEDs) or fiber-optic elements, audible alarms such as beeping, or tactile alarms such as vibration of the faucet, or pulsation of the water stream exiting the faucet. A warning signal can also be transmitted over the network 120, e.g., to computer 132, in order to inform a user or home owner.

If water safety cannot be restored by an automated disinfection or an enhanced water purification cycle and flow remains restricted, a manual override of the fail-safe can enable normal flow to be restored to the system. Embedded into the identification module 218 is a means to record and document alerts and user responses to alerts (e.g., override vs. not override) to indicate that the user recognized that a boil-water advisory had been received, that the system was either able or unable to produce water of sufficient quality to overcome the boil-water advisory or other sub-standard incoming water condition and that the user either elected to allow the system to function automatically or elected to override the system and dispense water anyway (e.g., for boiling or some other treatment) for example.

As described above, embodiments incorporate a radio receiver into the faucet or faucet/water treatment system, e.g., coupled to or embedded into the monitor 112 to receive a signal from a household or business wireless internet system, Wi-Fi signal or broadcast radio signal.

In another embodiment a dedicated radio frequency for broadcasting of boil water advisories or emergency alerts affecting public water supply and/or other emergency situations can be used.

Another embodiment of this invention employs a website and field deployed water treatment systems that automatically communicate with the website to obtain alerts and record responses taken.

As described above, in an embodiment, an internal, real-time monitoring system for water quality and system performance is utilized based on sensors 110. This monitoring system captures data and returns the system status and performance via the network 120 to the user and/or a 3rd party such as the device manufacturer or municipal water supplier. This data can then be analyzed to determine maintenance and replacement element requirements for the POU/POE treatment system and alert the municipal water supplier to changes that may be necessary in its water treatment regimen or distribution system.

A benefit of this reporting feature is that it provides a network of data gathering points for municipal water quality monitoring at the point of use. This can improve on the assessment of the efficacy and quality of water treatment efficacy and on the condition and integrity of municipal water distribution infrastructure.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention.

What is claimed is:

1. A computer based method for determining sanitation protocols for a liquid dispensing device comprising the steps of:
automatically identifying a first user located in proximity to the liquid dispensing device;
automatically determining whether a first liquid treatment/enhancement protocol is associated with said first user; and
implementing said first liquid treatment/enhancement protocol when said first user utilizes the liquid dispensing device.

2. The computer based method of claim 1, wherein said step of implementing said first liquid treatment protocol comprises:
performing a liquid treatment operation on a liquid before said liquid is dispensed by the liquid dispensing device.

3. The computer based method of claim 2, wherein said liquid treatment operation comprises:
performing a cleansing operation on said liquid including at least one of exposing the liquid to ultra-violet radiation, filtering the liquid, distilling the liquid, applying disinfecting chemicals to the liquid and/or passing the liquid through an absorption media.

4. The computer based method of claim 2, wherein said step of implementing said first liquid treatment protocol comprises:
performing a mixing operation on said liquid before said liquid is dispensed by the liquid dispensing device.

5. The computer based method of claim 4, wherein said mixing operation includes mixing one of a cleansing agent and/or an enhancement agent with said liquid.

6. The computer based method of claim 1, wherein said step of implementing said first liquid treatment protocol comprises:
performing a mixing operation on a liquid before said liquid is dispensed by the liquid dispensing device.

7. The computer based method of claim 6, wherein said mixing operation includes mixing one of a cleansing agent and/or an enhancement agent with said liquid.

8. A computer based method for determining sanitation protocols for a liquid dispensing device in a plumbing system comprising the steps of:
identifying a safety status of the liquid;
automatically determining whether a first liquid treatment protocol is necessary based on said safety status; and
implementing said first liquid treatment protocol when said first liquid treatment protocol is necessary based upon said safety status.

9. The computer based method of claim 8, wherein said step of identifying said safety status comprises monitoring a liquid in the plumbing system.

10. The computer based method of claim 9, wherein said monitoring step includes:
performing an analysis of the liquid including at least one of a chemical analysis, optical analysis, pressure analysis, and/or contaminant analysis.

11. The computer based method of claim 9, wherein said step of implementing said first liquid treatment protocol comprises:
performing a liquid treatment operation on said liquid before said liquid is dispensed by the liquid dispensing device.

12. The computer based method of claim 11, wherein said liquid treatment operation comprises:
performing a cleansing operation on said liquid including at least one of exposing said liquid to ultra-violet radiation, filtering said liquid, distilling said liquid, applying disinfecting chemicals to said liquid and/or passing said liquid through an absorption media.

13. The computer based method of claim 8, wherein said step of identifying said safety status comprises monitoring a third party communication related to said safety status of said liquid.

14. The computer based method of claim 13, wherein said step of implementing said first liquid treatment protocol comprises:
performing a liquid treatment operation on a liquid before said liquid is dispensed by the liquid dispensing device.

15. The computer based method of claim 14, wherein said liquid treatment operation comprises:
performing a cleansing operation on said liquid including at least one of exposing said liquid to ultra-violet radiation, filtering said liquid, distilling said liquid, applying disinfecting chemicals to said liquid and/or passing said liquid through an absorption media.
